(19) United States
(12) Patent Application Publication
(10) Pub. No.: US 2026/0133469 A1
(43) Pub. Date: May 14, 2026

(54) VARIABLE APERTURE AND CAMERA MODULE

(71) Applicant: Luxshare Intelligent Manufacture Technology (Changshu) Co., Ltd, Changshu City (CN)

(72) Inventors: Lijhen CHEN, Changshu City (CN); Poying TSENG, Changshu City (CN); Yihsuan CHENG, Changshu City (CN); Fuyuan WU, Changshu City (CN)

(73) Assignee: Luxshare Intelligent Manufacture Technology (Changshu) Co., Ltd, Changshu City (CN)

(21) Appl. No.: 19/025,743

(22) Filed: Jan. 16, 2025

(30) Foreign Application Priority Data
Nov. 12, 2024 (CN) 202411612773.5

(51) Int. Cl. G03B 9/06

(52) U.S. Cl. CPC G03B 9/06

(57) ABSTRACT

The present disclosure relates to the technical field of camera modules. Specifically provided are a variable aperture and a camera module. The variable aperture includes a housing, a rotary member rotatably connected to the housing, a driving member fixedly connected to the housing and multiple blades. Each of the multiple blades is rotatably connected to the rotary member and is slidably connected to the housing. The multiple blades enclose to form an aperture hole with an adjustable bore diameter. A guide groove is disposed on one of each of the multiple blades and the housing, and the other of each of the multiple blades and the housing is connected to a guide column. The guide column is inserted into the guide groove. An outer diameter of the guide column is not less than a groove width of the guide groove.

### CROSS-REFERENCE TO RELATED APPLICATION

This application claims priority to Chinese Patent Application No. 202411612773.5 filed Nov. 12, 2024, the disclosure of which is incorporated herein by reference in its entirety.

### TECHNICAL FIELD

The present disclosure relates to the technical field of camera modules and, in particular, to a variable aperture and a camera module.

### BACKGROUND

Camera modules for taking photos or videos are generally disposed on electronic devices such as mobile phones and tablet computers. The camera module generally includes an optical lens for imaging the shot scene, a motor for driving the optical lens to move and a variable aperture disposed on the light incident side of the optical lens.

In the related art, a variable aperture generally includes a housing, a rotor rotatably disposed on the housing, a stator fixedly disposed on the housing and multiple blades uniformly distributed along a circumferential direction of the rotor. A guide groove is disposed on each blade. Multiple guide columns are disposed on the stator and are slidably inserted into multiple guide grooves in one-to-one correspondence. First ends of the multiple blades are all rotatably connected to the rotor, and second ends of the multiple blades enclose to form an aperture hole. When the rotor rotates relative to the housing, the blades slide relative to the stator and rotate relative to the rotor under the drive of the rotor, thereby making the bore diameter of the aperture hole adjustable. However, a clearance fit that generally exists between the guide groove and the guide column leads to an uncontrollable stroke amount of the blades when the bore diameter of the aperture hole is adjusted to a specified size, thereby affecting the control accuracy of the bore diameter of the aperture hole.

In this regard, the related art provides a variable aperture. Elastic holes are further disposed on blades. The elastic hole is located on one side of a guide groove. An elastic rib is formed between the elastic hole and the guide groove. In this manner, an interference fit can exist between the guide groove and a guide column to ensure that the guide column can slide inside the guide groove through the elastic deformation of the rib, thereby improving the problem of an uncontrollable stroke amount of the blades when a size of an aperture hole is controlled. However, the middle portion of the elastic rib is more susceptible to deformation than the two ends of the elastic rib. Therefore, when the bore diameter of the aperture hole is adjusted, the control accuracy of the stroke amount of the guide column is relatively low when the guide column stops at the middle portion of the elastic rib relative to the case where the guide column stops at the two ends of the elastic rib, thereby affecting the control accuracy of the bore diameter of the aperture hole to a certain extent.

Therefore, there is an urgent need for a variable aperture and a camera module to solve the above technical problems.

### SUMMARY

An object of the present disclosure is to provide a variable aperture and a camera module to improve the control accuracy of a bore diameter of an aperture hole.

On the one hand, the present disclosure provides a variable aperture. The variable aperture includes a housing, a rotary member rotatably connected to the housing, a driving member fixedly connected to the housing and multiple blades. Each of the multiple blades is rotatably connected to the rotary member and is slidably connected to the housing. The multiple blades enclose to form an aperture hole with an adjustable bore diameter. A guide groove is disposed on one of each of the multiple blades and the housing, and the other of each of the multiple blades and the housing is connected to a guide column. The guide column is inserted into the guide groove. An outer diameter of the guide column is not less than a groove width of the guide groove. The guide column has elasticity.

As a preferred technical solution for the variable aperture, the guide column is in a cylindrical shape or is in a circular shape.

As a preferred technical solution for the variable aperture, the guide column includes multiple first elastic ribs arranged in a circle, any two adjacent first elastic libs are disposed at intervals, and each of the multiple first elastic ribs passes through the guide groove.

As a preferred technical solution for the variable aperture, each of the multiple first elastic ribs is in an arc shape and has an inner sidewall and an outer sidewall, and along a groove width direction of the guide groove, the guide groove has a first groove wall and a second groove wall that are disposed at intervals.

The first groove wall abuts against and tangentially fits with an outer sidewall of one of the multiple first elastic ribs, and the second groove wall abuts against and tangentially fits with an outer sidewall of another first elastic rib among the multiple first elastic ribs.

As a preferred technical solution for the variable aperture, each of the multiple first elastic ribs is made of a plastic material.

As a preferred technical solution for the variable aperture, the blade is rotatably connected to the rotary member via a rotating shaft, and a second deformation groove is further disposed on each of the multiple blades and is located on a side of the guide groove facing away from the rotating shaft or a side of the guide groove facing the rotating shaft.

A second elastic rib is formed between the second deformation groove and the guide groove.

As a preferred technical solution for the variable aperture, a third deformation groove is further disposed on each of the multiple blades, the second deformation groove is located on the side of the guide groove facing the rotating shaft, and the third deformation groove is located on the side of the guide groove facing away from the rotating shaft.

A third elastic rib is formed between the third deformation groove and the guide groove.

As a preferred technical solution for the variable aperture, a width of the second elastic rib is equal to a width of the third elastic rib.

As a preferred technical solution for the variable aperture, each of the third deformation groove and the guide groove is in an arc shape, the second deformation groove is in an arc shape or in a circular shape, and circle centers of the guide groove, the second deformation groove and the third deformation groove coincide with each other.

The variable aperture provided in the present disclosure has at least the beneficial effects described below.

In the variable aperture, the guide groove is disposed on one of each of the multiple blades and the housing, the other of each of the multiple blades and the housing is connected to a guide column, the guide column is inserted into the guide groove; the outer diameter of the guide column is not less than the groove width of the guide groove, and the guide column has elasticity. An interference fit exists between the guide column and the guide groove, and the guide column adapts to the groove width of the guide groove by generating elastic deformation so that the guide column can slide along the guide groove. Since no gap exists between the guide column and the guide groove, when the bore diameter of the aperture hole needs to be adjusted to a specified size, a stroke amount of the guide column sliding along the guide groove is controllable so that a stroke amount of the blades moving relative to the housing is controllable. Moreover, compared with the related art, by making the guide column elastic, when the guide column slides along the guide groove, an amount of elastic deformation of the guide column can always remain stable at various positions and consistent at various positions along a length direction of the guide groove, thereby significantly improving the control accuracy of various bore diameter sizes of the aperture hole.

On the other hand, the present disclosure provides a camera module. The camera module includes an optical lens, a motor and the variable aperture in any one of the above solutions. The variable aperture is disposed on a light incident side of the optical lens, and a relative position between the variable aperture and the optical lens is fixed. The motor is drivingly connected to the optical lens and is configured to drive the optical lens to move along a centerline direction of the optical lens.

The camera module provided in the present disclosure has at least the beneficial effects described below.

The above adjustable aperture is used in the camera module so that the control accuracy of the aperture hole is high, thereby ensuring a shooting effect of the camera module.

### BRIEF DESCRIPTION OF DRAWINGS

FIG. 1 is a structure diagram of a variable aperture in an embodiment of the present disclosure.

FIG. 2 is a first partial structure diagram of a variable aperture in an embodiment of the present disclosure.

FIG. 3 is an exploded view of a variable aperture in an embodiment of the present disclosure.

FIG. 4 is a first structure diagram of a base in a variable aperture in an embodiment of the present disclosure.

FIG. 5 is a second partial structure diagram of a variable aperture in an embodiment of the present disclosure.

FIG. 6 is a second structure diagram of a base in a variable aperture in an embodiment of the present disclosure.

FIG. 7 is an enlarged view of a position A in FIG. 6.

FIG. 8 is a third partial structure diagram of a variable aperture in an embodiment of the present disclosure.

FIG. 9 is a third structure diagram of a base in a variable aperture in an embodiment of the present disclosure.

FIG. 10 is an enlarged view of a position B in FIG. 9.

FIG. 11 is a first structure diagram of a blade in a variable aperture in an embodiment of the present disclosure.

FIG. 12 is a second structure diagram of a blade in a variable aperture in an embodiment of the present disclosure.

FIG. 13 is a third structure diagram of a blade in a variable aperture in an embodiment of the present disclosure.

### REFERENCE LIST

1 housing
11 base
111 second light-transmissive hole
112 annular boss
113 first mounting slot
114 rolling groove
12 shell
121 first light-transmissive hole
13 accommodation cavity
2 rotary member
21 second mounting slot
22 third mounting slot
3 driving member
31 coil
32 first magnet
33 second magnet
4 blade
41 guide groove
411 first groove wall
412 second groove wall
42 second deformation groove
43 third deformation groove
44 second elastic rib
45 third elastic rib
5 aperture hole
6 ball
7 rotating shaft
8 guide column
81 spring groove
82 first elastic rib
821 inner sidewall
822 outer sidewall

### DETAILED DESCRIPTION

The technical solutions of the present invention are described clearly and completely below in conjunction with the drawings. Apparently, the described embodiments are part, not all, of embodiments of the present invention. Based on the embodiments of the present invention, all other embodiments obtained by those of ordinary skill in the art without creative work are within the scope of the present invention.

In the description of the present disclosure, it is to be noted that orientations or position relations indicated by terms such as “center”, “upper”, “lower”, “left”, “right”, “vertical”, “horizontal”, “inner”, and “outer” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. Additionally, terms such as “first” and “second” are used only for the purpose of description and are not to be construed as indicating or implying relative importance. Terms “first position” and “second position” are two different positions. Moreover, when a first feature is described as “on”, “above”, or “over” a second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of the present disclosure, it is to be noted that the term “mounted”, “connected to each other”, or “connected” should be construed in a broad sense unless otherwise expressly specified and limited. For example, the term “connected” may refer to “fixedly connected”, “detachably connected”, or “integrated”, may refer to “mechanically connected” or “electrically connected”, or may refer to “connected directly”, “connected indirectly through an intermediary”, or “connected inside two elements”. For those of ordinary skill in the art, specific meanings of the preceding terms in the present invention may be understood based on specific situations.

The embodiments of the present invention are described below in detail. Examples of the embodiments are illustrated in the drawings, where the same or similar reference numerals throughout the drawings represent the same or similar elements or elements having the same or similar functions. The embodiments described below with reference to the drawings are illustrative and intended only to explain the present invention and cannot be construed as limiting the present invention.

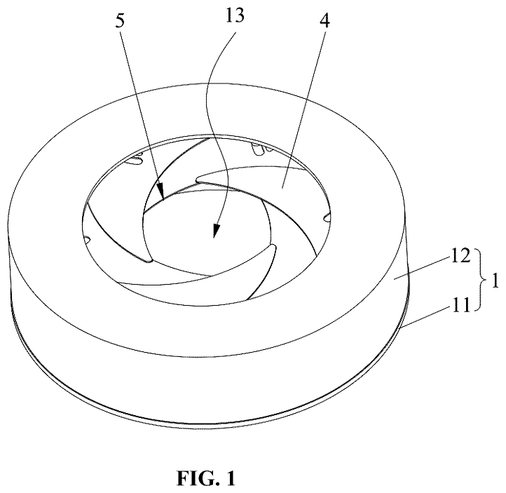

As shown in FIGS. 1 to 3, the present embodiment provides a variable aperture. The variable aperture includes a housing 1, a rotary member 2, a driving member 3 and multiple blades 4. The rotary member 2 is rotatably connected to the housing 1, the driving member 3 is fixedly installed on the housing 1, each of the multiple blades 4 is rotatably connected to the rotary member 2 and is slidably connected to the housing 1, the multiple blades 4 enclose to form an aperture hole 5 with an adjustable bore diameter. Specifically, when the driving member 3 drives the rotary member 2 to rotate relative to the housing 1, the rotary member 2 simultaneously drives the multiple blades 4 to slide relative to the housing 1, and the blades 4 simultaneously rotate relative to the rotary member 2 to adjust positions of the blades 4 relative to the housing 1, thereby adjusting the bore diameter of the aperture hole 5.

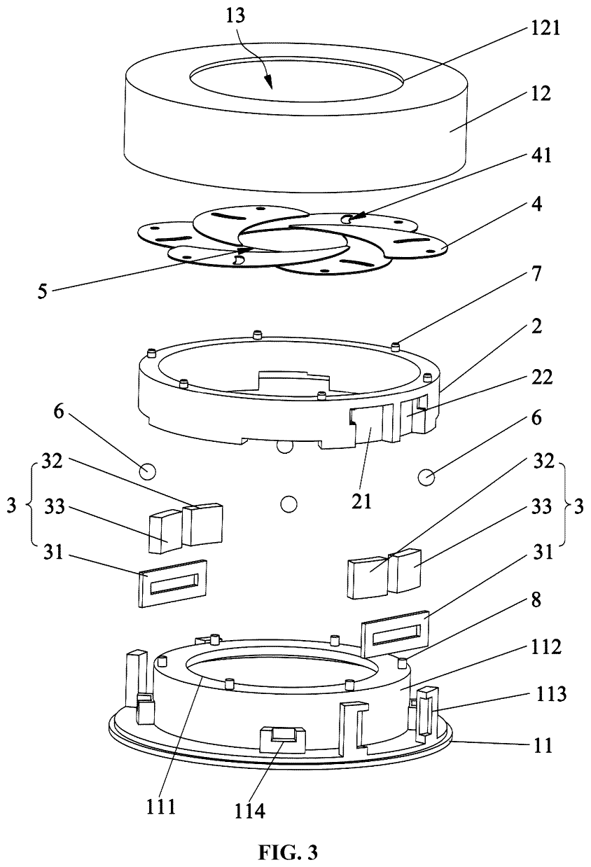

Referring to FIGS. 1 and 3, in the present embodiment, the housing 1 includes a base 11 and a shell 12. The shell 12 is covered on the base 11, the shell 12 and the base 11 enclose to form an accommodation cavity 13, and the rotary member 2, the driving member 3 and the multiple blades 4 are all located in the accommodation cavity 13 so that various parts in the accommodation cavity 13 can be protected by the shell 12. A first light-transmissive hole 121 is disposed on the shell 12, and a second light-transmissive hole 111 is disposed on the base 11. The first light-transmissive hole 121 and the second light-transmissive hole 111 are located on two sides of the aperture hole 5, respectively, and both the first light-transmissive hole 121 and the second light-transmissive hole 111 are opposite to the aperture hole 5. Both a bore diameter of the first light-transmissive hole 121 and a bore diameter of the second light-transmissive hole 111 are not less than a maximum bore diameter of the aperture hole 5.

Referring to FIG. 3, in the present embodiment, the rotary member 2 is a rotor, and the driving member 3 includes a coil 31 fixedly mounted on the base 11, a first magnet 32 fixedly mounted on the rotary member 2 and a second magnet 33 fixedly mounted on the rotary member 2. When the coil 31 is energized, the coil 31 generates a tangential force along a circumference direction of the rotary member 2 in cooperation with the first magnet 32 and the second magnet 33. Under an action of the tangential force, the rotary member 2 can be driven to rotate relative to the housing 1. In other embodiments, the driving member 3 may also be replaced with an electric motor.

It is to be noted that the variable aperture may include one or more driving members 3, and the specific number of driving members 3 may be selected according to an actual requirement. In the present embodiment, for example, a solution that the variable aperture includes two driving members 3 is provided. In other embodiments, the number of driving members 3 may also be one, three or more than three.

Optionally, with continued reference to FIG. 3, in the present embodiment, an annular boss 112 is disposed on the base 11, and the rotary member 2 is sleeved on the annular boss 112 and can rotate relative to the annular boss 112. This arrangement can improve the stability of the rotation of the rotary member 2. The base 11 and the annular boss 112 may be integrally formed, separately formed and connected via a connector or connected through processes such as welding.

Optionally, with continued reference to FIG. 3, in the present embodiment, the variable aperture further includes multiple balls 6. The multiple balls 6 are disposed between the rotary member 2 and the base 11 and are uniformly distributed along the circumferential direction of the rotary member 2. Each ball 6 simultaneously rolls and cooperates with the rotary member 2 and the base 11. In this manner, the smoothness of the rotation of the rotary member 2 relative to the housing 1 can be improved. Preferably, a rolling groove 114 is disposed on the base 11, and some balls 6 are located in the rolling groove 114 so that positions of the balls 6 are limited by the rolling groove 114. The specific number of balls 6 may be set according to an actual requirement. In the present embodiment, for example, a solution that the number of balls 6 is four is provided.

Optionally, with continued reference to FIG. 3, in the present embodiment, a first mounting slot 113 is further disposed on the base 11, and the coil 31 is embedded in the first mounting slot 113. In this manner, it can be ensured that the coil 31 is stably installed on the base 11.

Optionally, with continued reference to FIG. 3, in the present embodiment, a second mounting slot 21 is disposed on the rotary member 2 for each first magnet 32 on the rotary member 2, and the first magnet 32 is embedded in the corresponding second mounting slot 21; a third mounting slot 22 is disposed on the rotary member 2 for each second magnet 33 on the rotary member 2, and the second magnet 33 is embedded in the corresponding third mounting slot 22. In this manner, it can be ensured that both the first magnet 32 and the second magnet 33 are stably installed on the rotary member 2.

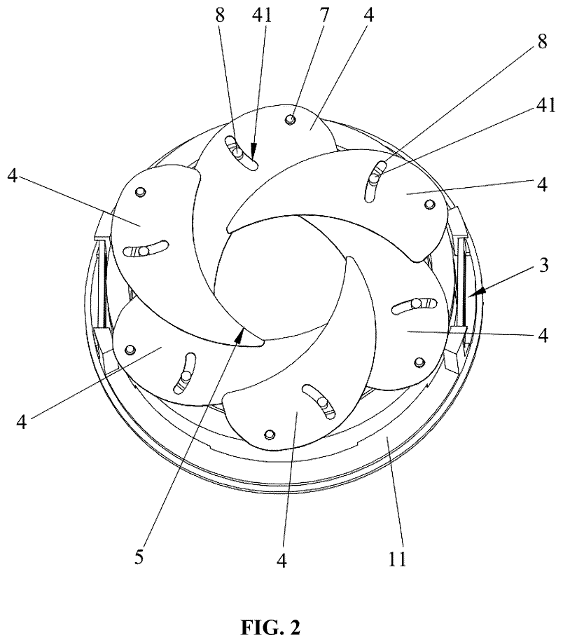

Optionally, referring to FIG. 2, a guide groove 41 is disposed on one of the blade 4 and the housing 1, the other of the blade 4 and the housing 1 is connected to a guide column 8, the guide column 8 is inserted into the guide groove 41, an outer diameter of the guide column 8 is not less than a groove width of the guide groove 41, and the guide column 8 has elasticity. With this arrangement, an interference fit exists between the guide column 8 and the guide groove 41, and the guide column 8 adapts to the groove width of the guide groove 41 by generating elastic deformation, and the guide column 8 can slide along the guide groove 41. Since no gap exists between the guide column 8 and the guide groove 41, when the bore diameter of the aperture hole 5 needs to be adjusted to a specified size, a stroke amount of the guide column 8 sliding along the guide groove 41 is controllable so that a stroke amount of the blade 4 moving relative to the housing 1 is controllable. Moreover, compared with the related art, by making the guide column 8 elastic, when the guide column 8 slides along the guide groove 41, the amount of elastic deformation of the guide column 8 can always remain stable at various positions and consistent at various positions along a length direction of the guide groove 41, thereby significantly improving the control accuracy of various bore diameter sizes of the aperture hole 5.

Specifically, in the present embodiment, the guide groove 41 is disposed on the blade 4, and the guide column 8 is connected to the base 11. The guide column 8 may be integrally formed or separately disposed with the base 11. In other embodiments, the guide groove 41 may also be disposed on the base 11, and the guide column 8 may also be connected to the blade 4.

Specifically, in the present embodiment, the outer diameter of the guide column 8 is greater than the groove width of the guide groove 41. In the present embodiment, the groove width of the guide groove 41 is specifically 0.155 mm, and the outer diameter of the guide column 8 is specifically 0.160 mm. In other embodiments, the groove width of the guide groove 41 and the outer diameter of the guide column 8 may also be set according to actual requirements, and the outer diameter of the guide column 8 may also be equal to the groove width of the guide groove 41.

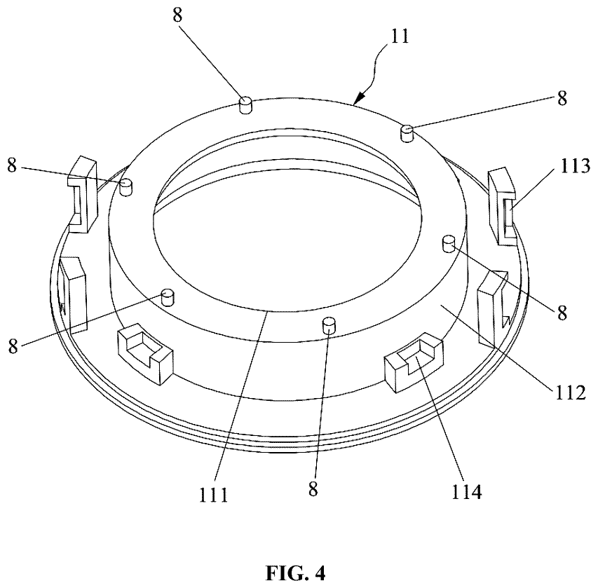

Optionally, referring to FIG. 4, the guide column 8 is in a cylindrical shape. In this case, the guide column 8 has elasticity and may be made of elastic materials such as polyurethane elastomer and rubber.

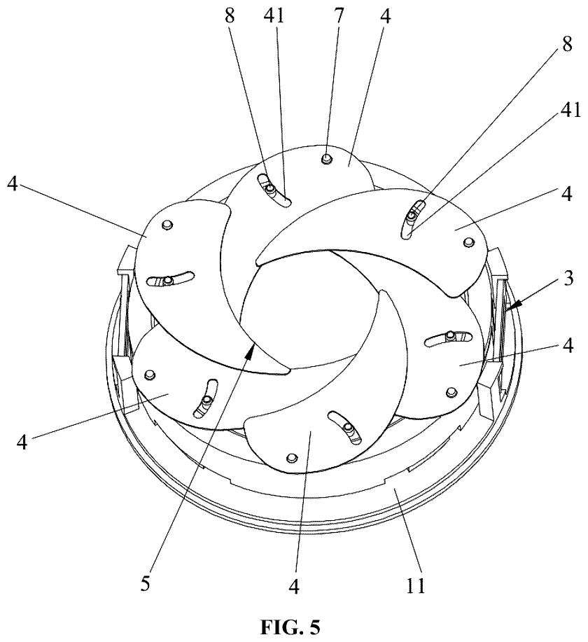

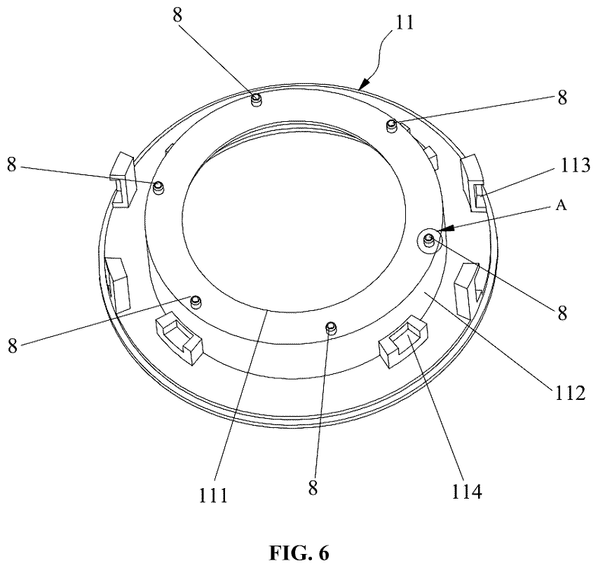

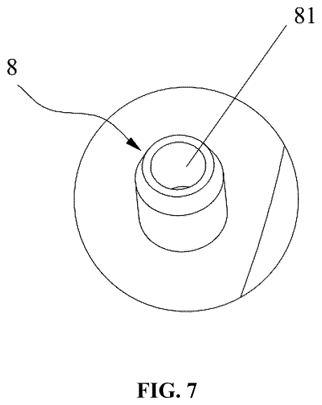

As one of the alternative solutions, referring to FIGS. 5 to 7, the guide column 8 may also be in a circular shape. That is, a spring groove 81 is disposed in a center of the guide column 8, and the guide column 8 is a thin-walled structure. The guide column 8 can generate elastic deformation and compress the spring groove 81 when the guide column 8 is subjected to a compressive force along a radial direction of the guide column 8, and/or the guide column 8 is made of an elastic material, and the guide column 8 can generate elastic deformation when the guide column 8 is subjected to a compressive force along a radial direction of the guide column 8. Preferably, in the present embodiment, along a groove depth direction of the spring groove 81, a notch end and a groove bottom end of the spring groove 81 are located on two sides of the guide groove 41, respectively, so as to ensure that the guide column 8 can normally generate elastic deformation to adapt to the groove width of the guide groove 41 when the guide column 8 is subjected to a radial force applied by a groove wall of the guide groove 41. It is to be noted that a groove depth of the spring groove 81 may be set according to an actual requirement. In the present embodiment, for example, a solution that the spring groove 81 has a depth of 0.335 mm and the guide column has a height of 0.390 mm is provided. A wall thickness of the guide column 8 may also be set according to an actual requirement. In the present embodiment, for example, a solution that the spring groove 81 has a depth of 0.06 mm is provided.

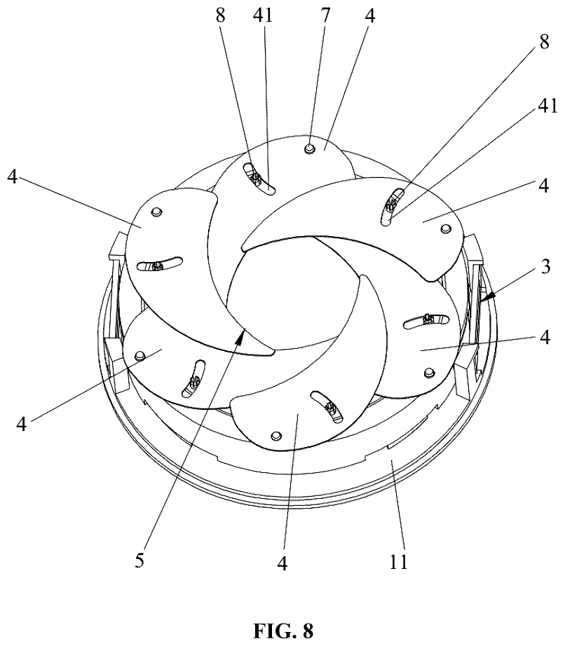

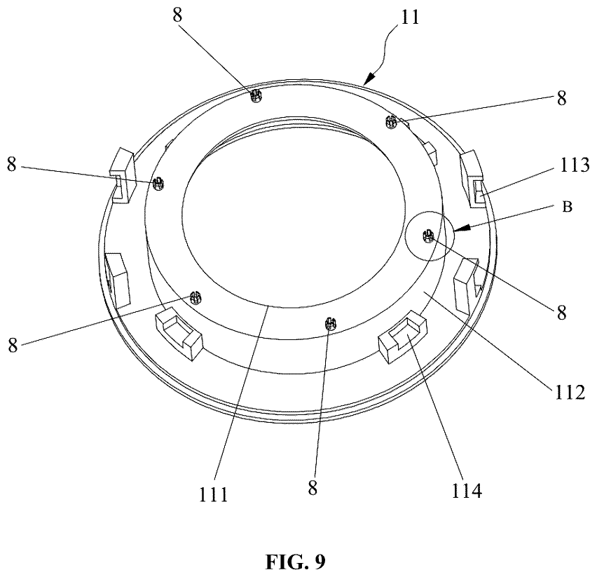

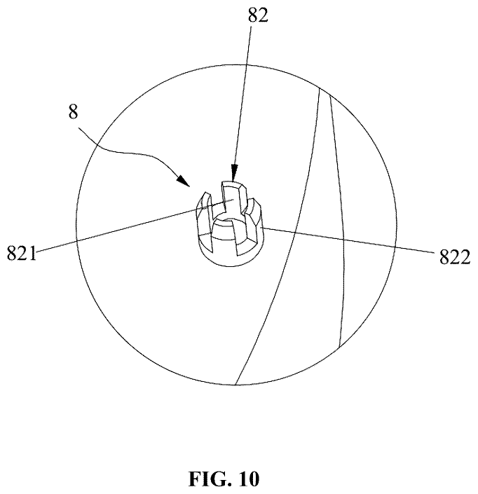

As one of the alternative solutions, referring to FIGS. 8 to 10, the guide column 8 includes multiple first elastic ribs 82 arranged in a circle, any two adjacent first elastic ribs 82 among the multiple first elastic ribs 82 are disposed at intervals, and each of the multiple first elastic ribs 82 passes through the guide groove 41. With this arrangement, the first elastic rib 82 has a slender structure, and the first elastic rib 82 generates elastic deformation to adapt to the groove width of the guide groove 41 without affecting the sliding of the guide column 8 along the guide groove 41 when the first elastic rib 82 is subjected to a compressive force applied by the groove wall of the guide groove 41. It is to be noted that the specific number of first elastic ribs 82 included in the guide column 8 may be set according to an actual requirement. In the present embodiment, for example, a solution that the guide column 8 includes four first elastic ribs 82 is provided. Preferably, the guide column 8 is made of plastic materials such as a PC material and an ABS material. In this case, the first elastic rib 82 is relatively hard and bends elastically inward when the first elastic rib 82 is subjected to the compressive force applied by the groove wall of the guide groove 41. Further preferably, each of the multiple first elastic ribs 82 is in an arc shape and has an inner sidewall 821 and an outer sidewall 822, and along a groove width direction of the guide groove 41, the guide groove 41 has a first groove wall 411 and a second groove wall 412 that are disposed at intervals; the first groove wall 411 abuts against and tangentially fits with an outer sidewall 822 of one of the multiple first elastic ribs 82, and the second groove wall 412 abuts against and tangentially fits with an outer sidewall 822 of another first elastic rib 82 among the multiple first elastic ribs 82. This arrangement can avoid that a gap between the two first elastic ribs 82 is opposite to the first groove wall 411 or the second groove wall 412, thereby ensuring that the guide column 8 can slide smoothly along the guide groove 41. Moreover, the two first elastic ribs 82 that are in cooperation with the first groove wall 411 or the second groove wall 412 deform simultaneously to ensure that the stroke amount of the guide column 8 sliding along the guide groove 41 is controllable, thereby further ensuring the control accuracy of the bore diameter of the aperture hole 5.

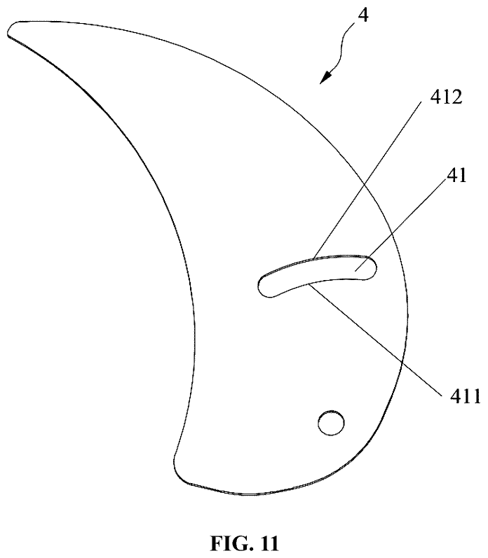

Optionally, referring to FIG. 11, only the guide groove 41 may be disposed on the blade 4, and the blade 4 is made of elastic materials such as rubber and polyurethane elastomer and can generate certain elastic deformation under an action of an external force. With this arrangement, both the guide column 8 and the blade 4 have elasticity, and the cooperation between the guide column 8 and the blade 4 can reduce an amount of elastic deformation of the guide column 8 to extend a service life of the guide column 8. It is to be noted that an elastic coefficient of the blade 4 may be equal to an elastic coefficient of the guide column 8 or the elastic coefficient of the blade 4 may be slightly less than the elastic coefficient of the guide column 8. Moreover, both the guide column 8 and the blade 4 can generate elastic deformation so that an amount of deformation is mainly concentrated on the guide column 8, thereby ensuring the control accuracy of the bore diameter of the aperture hole 5.

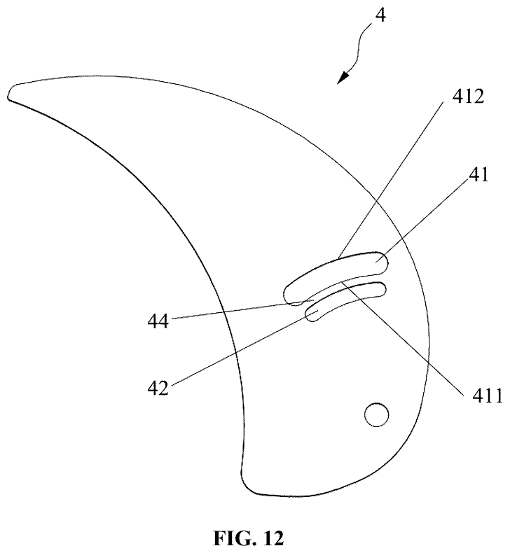

As one of the alternative solutions, referring to FIG. 12, the blade 4 is rotatably connected to the rotary member 2 via a rotating shaft 7, and a second deformation groove 42 is further disposed on each of the multiple blades 4 and is located on a side of the guide groove 41 facing away from the rotating shaft 7 or a side of the guide groove 41 facing the rotating shaft 7; a second elastic rib 44 is formed between the second deformation groove 42 and the guide groove 41. The second elastic rib 44 is a slender structure with elasticity and can generate certain elastic deformation under the compression of the guide column 8, and the guide column 8 and the second elastic rib 44 cooperate with each other to simultaneously generate elastic deformation, thereby reducing the amount of elastic deformation of the guide column 8 to extend the service life of the guide column 8. It is to be noted that an elastic coefficient of the second elastic rib 44 may be slightly less than the elastic coefficient of the guide column 8 so that an amount of deformation is mainly concentrated on the guide column 8, thereby ensuring the control accuracy of the bore diameter of the aperture hole 5. Specifically, in the present embodiment, for example, a solution that the second deformation groove 42 is located on the side of the guide groove 41 facing the rotating shaft 7 is provided. In other embodiments, the second deformation groove 42 may also be located on the side of the guide groove 41 facing away from the rotating shaft 7.

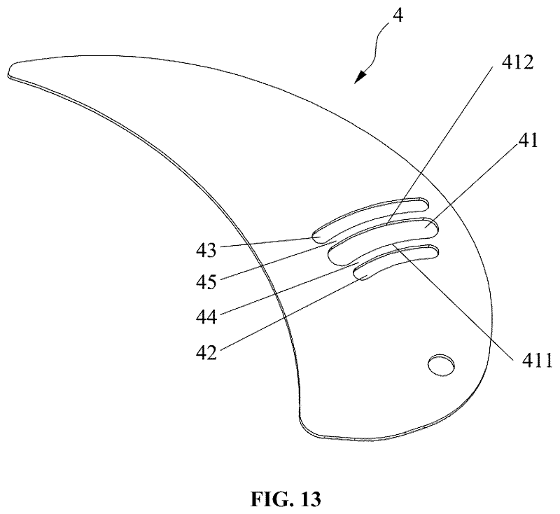

Optionally, referring to FIG. 13, a third deformation groove 43 is further disposed on each of the multiple blades 4, the second deformation groove 42 is located on the side of the guide groove 41 facing the rotating shaft 7, and the third deformation groove 43 is located on the side of the guide groove 41 facing away from the rotating shaft 7; a third elastic rib 45 is formed between the third deformation groove 43 and the guide groove 41. The third elastic rib 45 is also a slender structure with elasticity and can also generate certain elastic deformation under the compression of the guide column 8, and the guide column 8, the second elastic rib 44 and the third elastic rib 45 cooperate with each other to simultaneously generate elastic deformation, thereby further reducing the amount of elastic deformation of the guide column 8 to extend the service life of the guide column 8. Moreover, the second elastic rib 44 and the third elastic rib 45 simultaneously generate elastic deformation so that deformation amplitudes on two sides of the guide groove 41 can be consistent, thereby ensuring that the stroke amount of the guide column 8 relative to the guide groove 41 is controllable in a process of adjusting the bore diameter of the aperture hole 5 and further ensuring the control accuracy of the bore diameter of the aperture hole 5.

Optionally, with continued reference to FIG. 13, a width of the second elastic rib 44 is equal to a width of the third elastic rib 45. With this arrangement, an elastic coefficient of the third elastic rib 45 is equal to the elastic coefficient of the second elastic rib 44 so that an amount of deformation is mainly concentrated on the guide column 8, thereby ensuring the control accuracy of the bore diameter of the aperture hole 5.

Optionally, each of the third deformation groove 43 and the guide groove 41 is in an arc shape, the second deformation groove 42 is in an arc shape or in a circular shape, and circle centers of the guide groove 41, the second deformation groove 42 and the third deformation groove 43 coincide with each other. With this arrangement, along an extension direction of the guide groove 41, deformation amplitudes on two sides of the guide groove 41 are consistent, and the smoothness of the sliding of the guide column 8 relative to the guide groove 41 can be improved.

Further, the guide groove 41, the second deformation groove 42 and the third deformation groove 43 cooperate with the guide column 8 to meet a motion track of the blade 4. Therefore, shapes of the guide groove 41, the second deformation groove 42 and the third deformation groove 43 are not limited to arcs or circles. Each of the guide groove 41, the second deformation groove 42 and the third deformation groove 43 is in an arc shape or in a circular shape, circle centers of the guide groove 41, the second deformation groove 42 and the third deformation groove 43 coincide with each other or circle centers of the guide groove 41, the second deformation groove 42 and the third deformation groove 43 don't coincide with each other third deformation groove coincide with each other.

The present embodiment further provides a camera module. The camera module includes an optical lens, a motor and the above variable aperture. The variable aperture is disposed on a light incident side of the optical lens, and a relative position between the variable aperture and the optical lens is fixed. The motor is drivingly connected to the optical lens and is configured to drive the optical lens to move along a centerline direction of the optical lens.

Apparently, the preceding embodiments of the present invention are only illustrative examples of the present invention and are not intended to limit embodiments of the present invention. Those of ordinary skill in the art may make changes or variations in other different forms based on the preceding description. All embodiments do not need to be and cannot be exhausted herein. Any modifications, equivalent substitutions, and improvements made within the spirit and principle of the present invention fall within the scope of the claims of the present invention.

What is claimed is:

1. A variable aperture, comprising a housing, a rotary member rotatably connected to the housing, a driving member fixedly connected to the housing and a plurality of blades, wherein each of the plurality of blades is rotatably connected to the rotary member and is slidably connected to the housing, the plurality of blades enclose to form an aperture hole with an adjustable bore diameter, a guide groove is disposed on one of each of the plurality of blades and the housing, the other of each of the plurality of blades and the housing is connected to a guide column, the guide column is inserted into the guide groove, an outer diameter of the guide column is not less than a groove width of the guide groove, and the guide column has elasticity.

2. The variable aperture according to claim 1, wherein the guide column is in a cylindrical shape or is in a circular shape.

3. The variable aperture according to claim 1, wherein the guide column comprises a plurality of first elastic ribs arranged in a circle, any two adjacent first elastic ribs among the plurality of first elastic ribs are disposed at intervals, and each of the plurality of first elastic ribs passes through the guide groove.

4. The variable aperture according to claim 3, wherein each of the plurality of first elastic ribs is in an arc shape and has an inner sidewall and an outer sidewall, and along a groove width direction of the guide groove, the guide groove has a first groove wall and a second groove wall that are disposed at intervals; and
the first groove wall abuts against and tangentially fits with an outer sidewall of one of the plurality of first elastic ribs, and the second groove wall abuts against and tangentially fits with an outer sidewall of another first elastic rib among the plurality of first elastic ribs.

5. The variable aperture according to claim 3, wherein each of the plurality of first elastic ribs is made of a plastic material.

6. The variable aperture according to claim 1, wherein each of the plurality of blades is rotatably connected to the rotary member via a rotating shaft, and a second deformation groove is further disposed on each of the plurality of blades and the second deformation groove is located on a side of the guide groove facing away from the rotating shaft or a side of the guide groove facing the rotating shaft; and
a second elastic rib is formed between the second deformation groove and the guide groove.

7. The variable aperture according to claim 6, wherein a third deformation groove is further disposed on each of the plurality of blades, the second deformation groove is located on the side of the guide groove facing the rotating shaft, and the third deformation groove is located on the side of the guide groove facing away from the rotating shaft; and
a third elastic rib is formed between the third deformation groove and the guide groove.

8. The variable aperture according to claim 7, wherein a width of the second elastic rib is equal to a width of the third elastic rib.

9. The variable aperture according to claim 7, wherein each of the third deformation groove and the guide groove is in an arc shape, the second deformation groove is in an arc shape or in a circular shape, and circle centers of the guide groove, the second deformation groove and the third deformation groove coincide with each other.

10. The variable aperture according to claim 2, wherein each of the plurality of blades is rotatably connected to the rotary member via a rotating shaft, and a second deformation groove is further disposed on each of the plurality of blades and the second deformation groove is located on a side of the guide groove facing away from the rotating shaft or a side of the guide groove facing the rotating shaft; and
a second elastic rib is formed between the second deformation groove and the guide groove.

11. A camera module, comprising an optical lens, a motor and the variable aperture according to claim 1, wherein the variable aperture is disposed on a light incident side of the optical lens, a relative position between the variable aperture and the optical lens is fixed, and the motor is drivingly connected to the optical lens and is configured to drive the optical lens to move along a centerline direction of the optical lens;
wherein the variable aperture comprises a housing, a rotary member rotatably connected to the housing, a driving member fixedly connected to the housing and a plurality of blades, wherein each of the plurality of blades is rotatably connected to the rotary member and is slidably connected to the housing, the plurality of blades enclose to form an aperture hole with an adjustable bore diameter, a guide groove is disposed on one of each of the plurality of blades and the housing, the other of each of the plurality of blades and the housing is connected to a guide column, the guide column is inserted into the guide groove, an outer diameter of the guide column is not less than a groove width of the guide groove, and the guide column has elasticity.

12. The camera module according to claim 11, wherein the guide column is in a cylindrical shape or is in a circular shape.

13. The camera module according to claim 11, wherein the guide column comprises a plurality of first elastic ribs arranged in a circle, any two adjacent first elastic ribs among the plurality of first elastic ribs are disposed at intervals, and each of the plurality of first elastic ribs passes through the guide groove.

14. The camera module according to claim 13, wherein each of the plurality of first elastic ribs is in an arc shape and has an inner sidewall and an outer sidewall, and along a groove width direction of the guide groove, the guide groove has a first groove wall and a second groove wall that are disposed at intervals; and
the first groove wall abuts against and tangentially fits with an outer sidewall of one of the plurality of first elastic ribs, and the second groove wall abuts against and tangentially fits with an outer sidewall of another first elastic rib among the plurality of first elastic ribs.

15. The camera module according to claim 13, wherein each of the plurality of first elastic ribs is made of a plastic material.

16. The camera module according to claim 11, wherein each of the plurality of blades is rotatably connected to the rotary member via a rotating shaft, and a second deformation groove is further disposed on each of the plurality of blades and the second deformation groove is located on a side of the guide groove facing away from the rotating shaft or a side of the guide groove facing the rotating shaft; and
a second elastic rib is formed between the second deformation groove and the guide groove.

17. The camera module according to claim 16, wherein a third deformation groove is further disposed on each of the plurality of blades, the second deformation groove is located on the side of the guide groove facing the rotating shaft, and the third deformation groove is located on the side of the guide groove facing away from the rotating shaft; and
a third elastic rib is formed between the third deformation groove and the guide groove.

18. The camera module according to claim 17, wherein a width of the second elastic rib is equal to a width of the third elastic rib.

19. The camera module according to claim 17, wherein each of the third deformation groove and the guide groove is in an arc shape, the second deformation groove is in an arc shape or in a circular shape, and circle centers of the guide groove, the second deformation groove and the third deformation groove coincide with each other.

20. The camera module according to claim 12, wherein each of the plurality of blades is rotatably connected to the rotary member via a rotating shaft, and a second deformation groove is further disposed on each of the plurality of blades and the second deformation groove is located on a side of the guide groove facing away from the rotating shaft or a side of the guide groove facing the rotating shaft; and
a second elastic rib is formed between the second deformation groove and the guide groove.
